(19) United States
(12) Patent Application Publication
(10) Pub. No.: US 2013/0047391 A1
(43) Pub. Date: Feb. 28, 2013

(54) ATTACHMENT JIG FOR ATTACHING SELF-PROPELLED DEVICE TO ENDOSCOPE

(71) Applicants: Takayuki NAKAMURA, Kanagawa (JP); Tsuyoshi Ashida, Kanagawa (JP); Yasunori Ohta, Kanagawa (JP); Shinichi Yamakawa, Kanagawa (JP); John J. Allen, Mendota Heights, MN (US)

(72) Inventors: Takayuki NAKAMURA, Kanagawa (JP); Tsuyoshi Ashida, Kanagawa (JP); Yasunori Ohta, Kanagawa (JP); Shinichi Yamakawa, Kanagawa (JP); John J. Allen, Mendota Heights, MN (US)

(21) Appl. No.: 13/591,555

(22) Filed: Aug. 22, 2012

Related U.S. Application Data
(60) Provisional application No. 61/526,553, filed on Aug. 23, 2011.

(51) Int. Cl. B25B 11/02

(52) U.S. Cl. 29/270

(57) ABSTRACT

A cylinder portion is inserted into a gap fanned between an outer peripheral surface of a tip end rigid portion of an endoscope and an inner peripheral surface of a self-propelled device from the side of a tip end face of the tip end rigid portion. A ring portion is disposed at a front end side of the cylinder portion, and a handle portion is disposed at a rear end side thereof. A position regulating portion for receiving the tip end face of the tip end rigid portion to define an insertion position of the tip end rigid portion is disposed in the cylinder portion. In some instances, the self-propelled device moves to a fixed position on the tip end rigid portion, and is fixed thereto by the ring portion. The cylinder portion is separated from the ring portion, and pulled out from the tip end rigid portion.

### BACKGROUND OF THE INVENTION

1. Field of the Invention

The present invention relates to an attachment jig for attaching a self-propelled device to an endoscope, the self-propelled device assisting insertion of the endoscope into a body cavity.

2. Description of the Related Art

An endoscope has been widely used for examination of a body cavity of a patient. The endoscope has an insertion section to be inserted into a body cavity, and a manipulation section to be gripped by an operator. The insertion section consists of a short tip end rigid portion provided at the tip end thereof, a bending portion which is continuously provided at the base end of the tip end rigid portion and can be bent at will in order to turn the tip end rigid portion in a desired direction, and a long (about 1 m to 2 m, varying depending on application) flexible tube portion continuously provided at the base end of the bending portion. An image capturing window for capturing an image of a part to be observed inside a body cavity, and the like, are arranged at the tip end face of the tip end rigid portion.

In endoscopic examination of the large intestine, insertion of an endoscope into the large intestine is very difficult, since the large intestine has a meandering structure in the body, and the large intestine has parts that are not fixed inside the body. Therefore, a great deal of experience is required to master the technique for insertion of the endoscope into the large intestine, and if the insertion technique is unskilled, the insertion procedure can be very painful for a patient.

There is known a self-propelled device that is attached to an insertion section in order to assist insertion of the insertion section into a body cavity. The self-propelled device has a movable body which is formed in the shape of a hollow toroid (in the shape of a doughnut) from a flexible sheet-like material and rotates (for example, refer to Japanese Patent Translation Publication No. 2009-513250).

The self-propelled device includes a driving unit that is fixed to the tip end rigid portion of the endoscope, and a toroid unit that is supported by the driving unit and surrounded by the movable body in the shape of toroid. The movable body receives driving force from the inner peripheral side thereof through the driving mechanism of the driving unit to perform a circulation movement, and the outer peripheral side thereof comes into contact with an inner wall of the body cavity sequentially, so as to apply a propulsive force to the tip end rigid portion.

Naturally, the self-propelled device is required to be firmly fixed to the tip end rigid portion such that the propulsive force thereof is efficiently transmitted and such that the self-propelled device does not come off the endoscope during use. Additionally, it is desirable that the attachment operation of the self-propelled device be easy. Further, since the self-propelled device is detached from the endoscope such that the endoscope can be washed and disinfected after the endscope is used, it is desirable that the detachment operation of the self-propelled device also be easy. In order to attach the self-propelled device to the tip end rigid portion, there are some attachment methods including screwing, press-fitting, bayoneting, engagement of a locking claw, and the like. However, in these attachment methods, large attachment space is required to reliably fix the self-propelled device to the tip end rigid portion, and besides, it is difficult to keep the position at which the self-propelled device is fixed to the tip end rigid portion constant. If the attachment position of the self-propelled device is retracted to be located on the bending portion, hindrance to the bending manipulation of the endoscope is apt to occur. On the contrary, if the attachment position of the self-propelled device gets near to the tip end side of the tip end rigid portion, the self-propelled device considerably protrudes from the tip end rigid portion, and therefore there arises a problem such as occurrence of vignetting in the field of view for the solid state imaging device.

### SUMMARY OF THE INVENTION

An object of the present invention is to provide; an attachment jig capable of fixing a self-propelled device at a predetermined fixed position precisely while saving attachment space.

In order to achieve the above and other objects, an attachment jig of the present invention includes a cylinder portion, a position regulating portion, a ring portion, and a handle portion, and is used in fixing a self-propelled device to a tip end rigid portion of an endscope. The cylinder portion is inserted into a gap formed between an outer peripheral surface of the tip end rigid portion and an inner peripheral surface of the self-propelled device from the side of a tip end face of the tip end rigid portion in a state that the tip end rigid portion is inserted into the self-propelled device. The position regulating portion is provided inside the cylinder portion. The position regulating portion abuts on the tip end face of the tip end rigid portion so as to define an insertion position of the tip end rigid portion inside the cylinder portion. The ring portion is threadedly engaged with the self-propelled device. The ring portion fixes the self-propelled device to a fixed position on the tip end rigid portion, and then separates from the front end side of the cylinder portion. The handle portion is provided at a rear end side of the cylinder portion. The handle portion serves for causing relative movement between the self-propelled device and the tip end rigid portion, fixing the self-propelled device to the fixed position, separating the ring portion from the cylinder portion after fixing the self-propelled device, and taking out the cylinder portion from the tip end rigid portion while leaving the ring portion in the self-propelled device.

The ring portion preferably has an elastic member attached to its front end. The elastic member is pinched between the ring portion and a part of the self-propelled device and pressed against the outer peripheral surface of the tip end rigid portion so as to fix the self-propelled device to the fixed position. The elastic member is preferably an O-ring made of rubber.

The threaded engagement is conducted using an external thread formed at an outer periphery of the cylinder portion and an inner thread formed at an inner peripheral surface of the self-propelled device.

The position regulating portion is preferably a shoulder disposed in the cylinder portion so as to receive an outer peripheral edge of the tip end rigid portion. The shoulder preferably has a ring shape inclined such that its diameter increases toward the handle portion.

It is preferable that a position regulating cylinder is fitted into the cylinder potion. An opening edge of the position regulating cylinder is used as the shoulder. The position regulating cylinder is rotatable inside the cylinder portion with use of a hemispherical projection and a hemispherical concave portion.

It is preferable that the ring portion is separated from the cylinder portion when the handle portion is caused to rotate by at least a predetermined torque after the self-propelled device is fixed to the fixed position.

Preferably, the attachment jig is integrally molded from plastic, in which a thin-walled breaking portion is disposed between the ring portion and the cylinder portion. When the handle portion is caused to rotate in a first direction by a torque below the predetermined level, the thin-walled breaking portion is not broken, and relative movement between the self-propelled device and the tip end rigid portion toward the fixed position is caused. When the handle portion is caused to rotate at the fixed position by a torque of at least the predetermined level, the thin-walled breaking portion is broken to form two broken surfaces.

The thin-walled breaking portion has a saw-tooth shape, such that after the thin-walled breaking portion is broken, the two broken surfaces are not engaged with each other when the handle portion is caused to rotate in the first direction, and the two broken surfaces are engaged with each other when the handle portion is caused to rotate in a second direction opposite to the first direction.

The thin-walled breaking portion having a saw-tooth shape consists of a plurality of straight grooves extending in an axial direction of the cylinder portion, a plurality of diagonal grooves, and a plurality of circular arc grooves extending in a circumferential direction of the cylinder portion. The circular arc groove connects the straight groove and the diagonal groove adjacent to each other.

According to the present invention, since the attachment jig is provided with the position regulating portion for defining the position of the tip end rigid portion, it is possible to precisely fix the self-propelled device to the fixed position on the tip end rigid portion.

Further, since the ring portion is inserted into the gap formed between the insertion section of the endoscope and the self-propelled device so as to be fixed thereto, the required attachment space is small.

Furthermore, it is sufficient to manipulate the handle portion in order to fix the self-propelled device by the ring portion, separate the ring portion from the cylinder portion, and take out the cylinder portion from the tip end rigid portion. Additionally, it is possible to remove the ring portion from the self-propelled device such that the self-propelled device is released from the fixed state by causing the handle portion to rotate after fitting the cylinder portion into the tip end rigid portion. Consequently, the attachment operation and the detachment operation of the self-propelled device are easy.

### BRIEF DESCRIPTION OF THE DRAWINGS

The above object and advantages can be easily understood by those skilled in the art by reading the detailed description of the preferred embodiments of the present invention with reference to the attached drawings:

FIG. 1 is a schematic view of an endoscope equipped with a self-propelled device;

FIG. 2 is a cross-sectional view of the self-propelled device;

FIG. 3 is a view showing an insertion section of the endoscope inserted through the self-propelled device, in which the insertion section is illustrated in a perspective manner as a matter of convenience;

FIG. 4 is a perspective view showing an attachment jig, the self-propelled device, and the insertion section of the endoscope;

FIG. 5 is a cross-sectional view of the attachment jig;

FIG. 6 is a partial enlarged view explaining a thin-walled breaking portion of the attachment jig;

FIG. 7 is a flowchart showing a procedure for attaching the self-propelled device;

FIG. 8 is an enlarged cross-sectional view showing a state where the self-propelled device is fixed to a tip end rigid portion of the endoscope by the attachment jig;

FIG. 9 is a view showing a state where the thin-walled breaking portion is broken and a ring portion is separated from the attachment jig;

FIG. 10 is an explanatory view showing a state where the self-propelled device is detached from the tip end rigid portion by the attachment jig; and

FIG. 11 is a cross-sectional view explaining an attachment jig according to another embodiment of the present invention.

### DESCRIPTION OF THE PREFERRED EMBODIMENTS

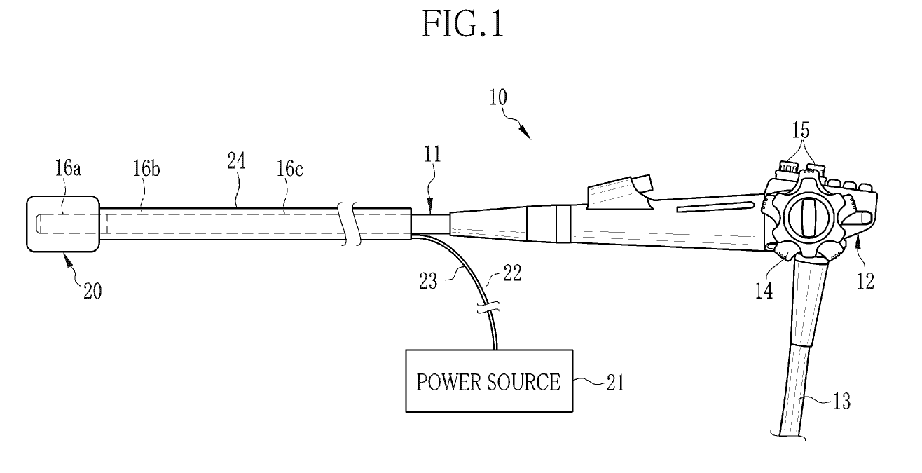

As shown in FIG. 1, an endoscope 10 consists of an insertion section 11 to be inserted into alimentary canals such as the large intestine, a manipulation section 12 used for the gripping of the endoscope 10 and the manipulation of the insertion section 11, and a universal cord 13 for connecting the endoscope 10 to a processor device and a light source device (both of them not shown). The insertion section 11 includes a tip end rigid portion 16a, a bending portion 16b, and a flexible tube portion 16c. A solid-state image sensing device (a CCD sensor, a CMOS sensor, or the like) is incorporated into the tip end rigid portion 16a. The universal cord 13 contains an air/water supply channel, a cable for outputting imaging signals, and a light guide. The manipulation section 12 includes a pair of angle knobs 14 and a plurality of manipulation buttons 15.

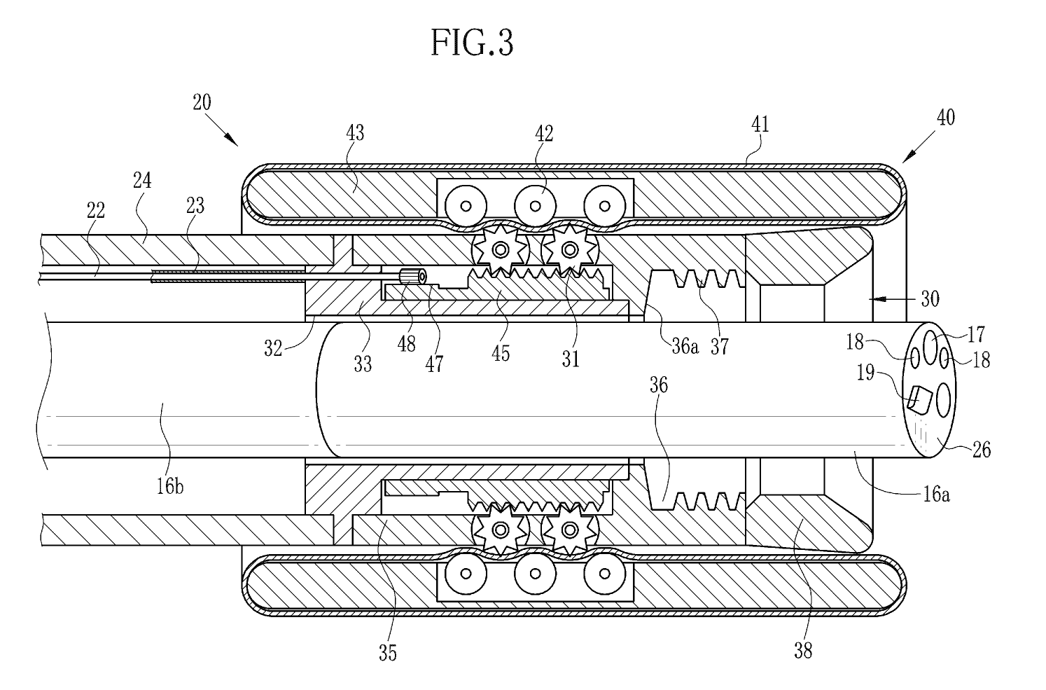

Each of the angle knobs 14 is manipulated to rotate at the time of bending the bending portion 16b in a vertical direction and a horizontal direction. In accordance with the rotational amount of the angle knob 14, the bending direction of the bending portion 16b is defined. The respective manipulation buttons 15 are used for various kinds of manipulation, such as supplying air, supplying water, and suctioning. The flexible tube portion 16c is a flexible rod-shaped member. An image capturing window 17, illumination windows 18, an air/water nozzle 19, and the like are provided at a tip end face 26 of the tip end rigid portion 16a as shown in FIG. 3. The self-propelled device 20 is attached to the tip end side of the insertion section 11, for example, the tip end rigid portion 16a, and thereby, the insertion section 11 is advanced within the body cavity such as an alimentary canal.

The self-propelled device 20 is driven by a power source 21. The power source 21 has a motor and a motor controller. A torque wire 22 for transmitting rotary torque for moving the self-propelled device 20 is coupled to the motor. The torque wire 22 is covered with a protective sheath 23 over almost its entire length, and rotated within the protective sheath 23.

The motor controller of the power source 21 is connected to an operation unit (not shown). If operation signals for advancing, retracting, and stopping, and speed change signals from the operation unit are inputted to the motor controller, the driving of the motor is controlled based on these signals. A soft overtube 24 having high flexibility is connected to the self-propelled device 20, and the torque wire 22 is passed through the inside of the overtube 24 together with the protective sheath 23.

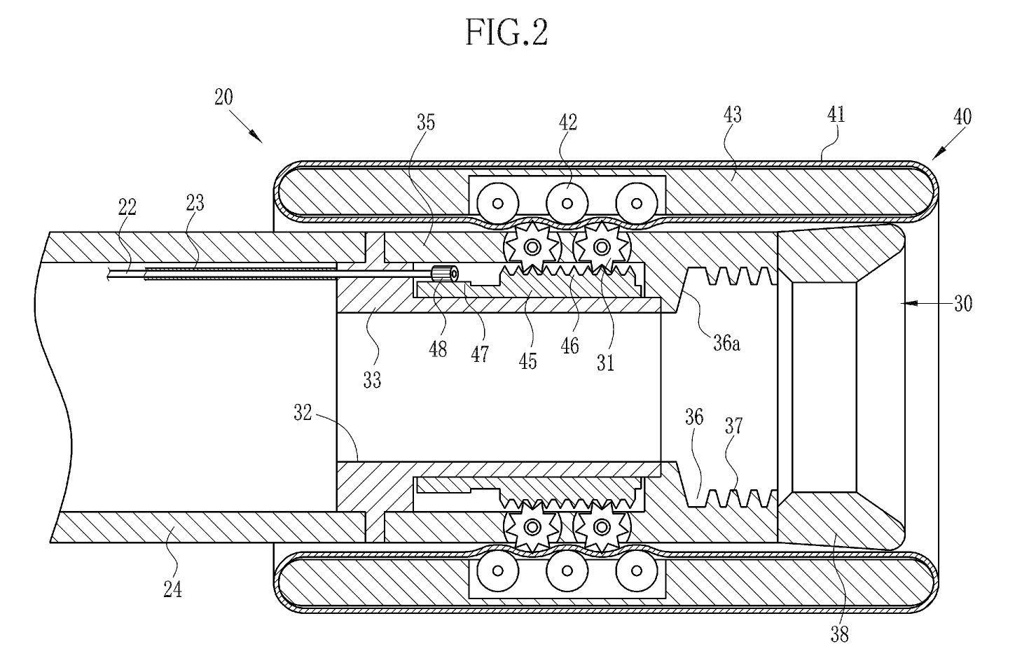

As shown in FIG. 2, the self-propelled device 20 includes a driving unit 30 having a tubular shape as a whole, and a tubular toroid unit 40 that is combined with the driving unit 30 so as to cover the outer peripheral side thereof. The driving unit 30 has an internal cylinder 33, a rotating cylinder 45 rotatably supported at an outer periphery of the internal cylinder 33, and an external cylinder 35 that rotatably supports driving wheels 31 and is fixed to the internal cylinder 33 so as to cover the rotating cylinder 45. A spur gear 47 is formed along an outer periphery of the rear end of the rotating cylinder 45, and a worm gear 46 is formed from a central portion of the rotating cylinder 45 to the front end thereof. A driving gear 48 fixed to the front end of the torque wire 22 meshes with the spur gear 47, and the driving wheels 31 mesh with the worm gear 46. Note that, each of the driving wheels 31 has low teeth, and has a shape of concave-convex roller.

The toroid unit 40 has a bag body 41 formed of a thin film sheet having elasticity and flexibility in a toroid shape, and a cylindrical roller supporting cylinder 43 that is arranged in an internal space of the bag body 41 and rotatably supports driven rollers 42. The driven rollers 42 come into contact with an inner surface on the inner peripheral side of the bag body 41, pinch the bag body 41 between the driven rollers 42 and the driving wheels 31, and transmit the rotation of the driving wheels 31 to the bag body 41.

If the driving gear 48 is rotated by the rotary torque of the torque wire 22, the rotating cylinder 45 rotates in conjunction with the rotation of the driving gear 48. If the worm gear 46 rotates together with the rotation of the rotating cylinder 45, the driving wheels 31 meshing with the worm gear 46 rotate. Since the driving wheels 31 pinch the bag body 41 between the driving wheels 31 and the driven rollers 42, the driven rollers 42 rotate together with the rotation of the driving wheels 31, and the bag body 41 receives the rotative forces of the driving wheels 31 on its inner peripheral side and performs a circulation movement in the axial direction as a whole. Since the surface on the outer peripheral side of the bag body 41 comes into contact with the inner wall of the body cavity, propulsive force in an advance direction or a retract direction is applied to the tip end rigid portion 16a depending on the movement direction of the bag body 41.

A hollow portion of the internal cylinder 33 is used as an insertion hole 32 that allows the tip end rigid portion 16a to pass therethrough. The tip end rigid portion 16a is inserted into the insertion hole 32 from the rear end side of the internal cylinder 33. The self-propelled device 20 is fixed to an outer peripheral surface of the tip end rigid portion 16a in a state where the tip end of the tip end rigid portion 16a is made to protrude from the front end of the internal cylinder 33. The external cylinder 35 protrudes toward the front end more than the internal cylinder 33. An internal thread 37 is formed in an inner peripheral surface of the external cylinder 35, and a concave portion 36 is formed at the rear end side of the internal thread 37. A receiving plane 36a having a diameter decreasing toward the backward is continuously provided to the concave portion 36 in an annular manner. A ring 38 made of an elastic material such as rubber is fixed to the front end of the external cylinder 35. The ring 38 reduces a gap between the external cylinder 35 and the bag body 41.

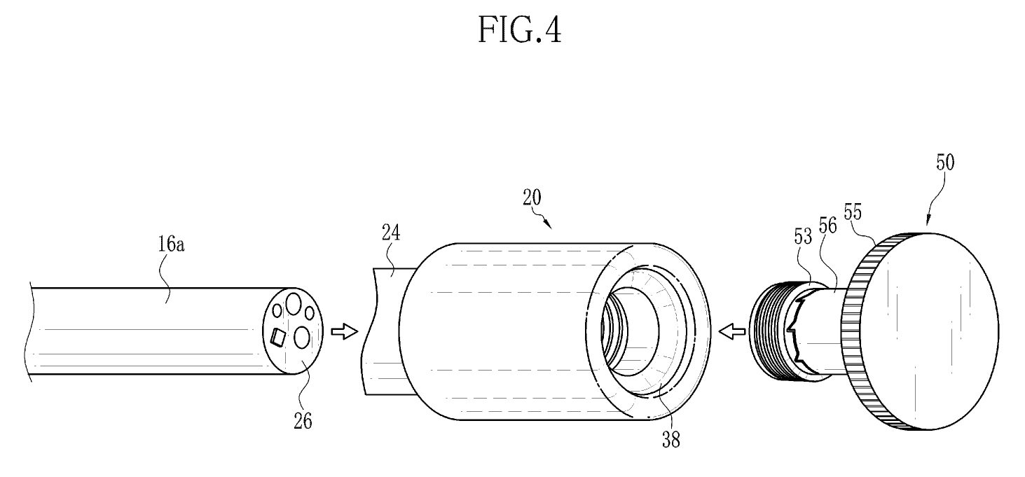

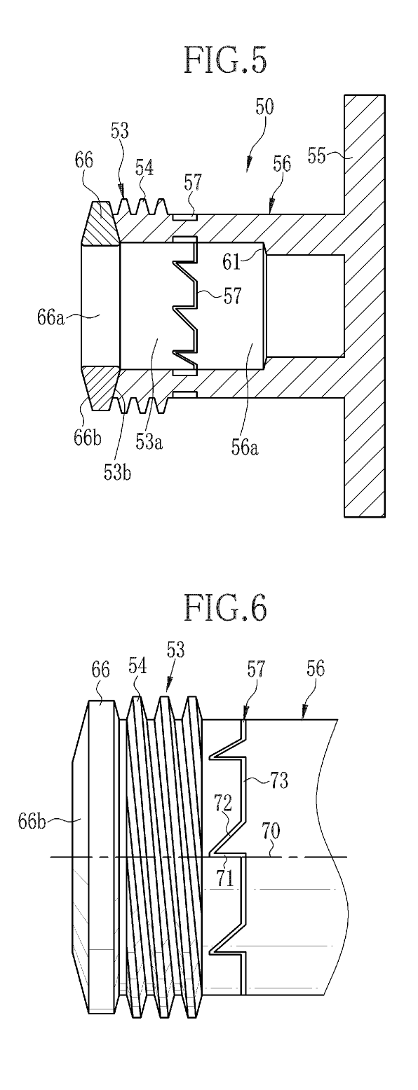

When the self-propelled device 20 is fixed to the tip end rigid portion 16a of the endoscope, a plastic attachment jig 50 shown in FIGS. 4 and 5 is used. The attachment jig 50 includes a handle portion 55 having a large diameter, a cylinder portion 56, and a cylindrical ring portion 53. The ring portion 53 is integrally molded with the cylinder portion 56. The ring portion 53 includes an O-ring 66 fixed to a front end face 53b thereof. The O-ring 66 is made of a material having high elasticity, such as rubber, and has a substantially trapezoidal cross-section. A front end face 66b of the O-ring 66 is formed as a reversed inclined plane so as to be symmetrical to the receiving plane 36a formed in the external cylinder 35 of the self-propelled device 20. Note that, instead of the O-ring 66, a plurality of segments constituting one O-ring 66 may be used.

An outer peripheral surface of the ring portion 53 is provided with an external thread 54 threadedly engaged with the internal thread 37 formed at the inner periphery of the external cylinder 35 of the self-propelled device 20. The external diameters of the cylinder portion 56 and the O-ring 66 are smaller than the internal diameter of the external cylinder 35. Accordingly, the attachment jig 50 can be inserted into the self-propelled device 20 from its front end side. In a state where the external thread 54 is threadedly engaged with the internal thread 37, the ring portion 53 can be screwed into the self-propelled device 20 by manipulating the handle portion 55 to rotate. Moreover, a hole 56a of the cylinder portion 56, a hole 53a of the ring portion 53, and the hole 66a of the O-ring 66 are larger than the external diameter of the tip end rigid portion 16a of the endoscope 10. Accordingly, even in a state where the tip end rigid portion 16a is made to protrude from the front end side of the self-propelled device 20 as shown in FIG. 3, the tip end rigid portion 16a can be inserted into the hole 66a of the O-ring 66, the hole 53a of the ring portion 53, and the hole 56a of the cylinder portion 56. It is thus possible to perform screwing manipulation of the attachment jig 50 by manipulating the handle portion 55 to rotate. Note that, the hole 56a of the cylinder portion 56 may penetrate through the handle portion 55.

An annular shoulder 61 is formed as a position regulating portion inside the hole 56a, such that the shoulder 61 can receive an outer peripheral edge of the tip end face 26 of the tip end rigid portion 16a, which is inserted into the hole 56a of the cylinder portion 56, so as to regulate the position of the tip end rigid portion 16a in the axial direction. The shoulder 61 has a small-diameter part formed from the middle of the hole 56a, and thereby the shoulder 61 is formed over the entire circumference of the cylinder portion 56. In this embodiment, the shoulder 61 is slightly inclined such that the diameter thereof increases gradually toward the handle portion 55. The shoulder 61 may be formed in a divided manner inside the hole 56a.

Such a shoulder 61 can be easily formed with use of a die to be used for molding the attachment jig 50. Furthermore, in FIG. 5, components peculiar to the endoscope such as the air/water nozzle 19, which protrude from the tip end face 26 of the tip end rigid portion 16, enter through the right side of the shoulder 61 into the hole 56a. However, the right side of the shoulder 61, which is slightly smaller in diameter, is not damaged.

A thin-walled breaking portion 57 is formed at the boundary between the ring portion 53 and the cylinder portion 56. Such a thin-walled breaking portion 57 can be easily made without conducting post-processing by performing working for molding a thin-walled portion on a molding die for obtaining a molded article before assembling the O-ring 66, that is, a molded article in which the handle portion 55, the cylinder portion 56, and the ring portion 53 are integrated together. The thin-walled breaking portion 57 is provided over the entire circumference of the cylinder portion 56, and breaks when a predetermined level or higher of torque is applied between the cylinder portion 56 and the ring portion 53.

As shown in FIG. 6, the shape pattern of the thin-walled breaking portion 57 is a saw-toothed pattern in which a straight groove 71 extending in the direction of a central axis 70 of the cylinder portion 56, a diagonal groove 72, and a circular arc groove 73 are sequentially connected. The diagonal groove 72 inclines in a direction in which the ring portion 53 and the cylinder portion 56 slip and the engagement therebetween is easily released if the cylinder portion 56 and the ring portion 53 are broken at the thin-walled breaking portion 57 and then re-engaged with each other so as to rotate the cylinder portion 56 in the fastening direction of a right-hand screw. In addition, it is possible to provide one or more slit-like openings at a part of the thin-walled breaking portion 57 in order to adjust the predetermined torque to a low value at the time when the thin-walled breaking portion 57 is broken, and also in this case, a molding die can be used.

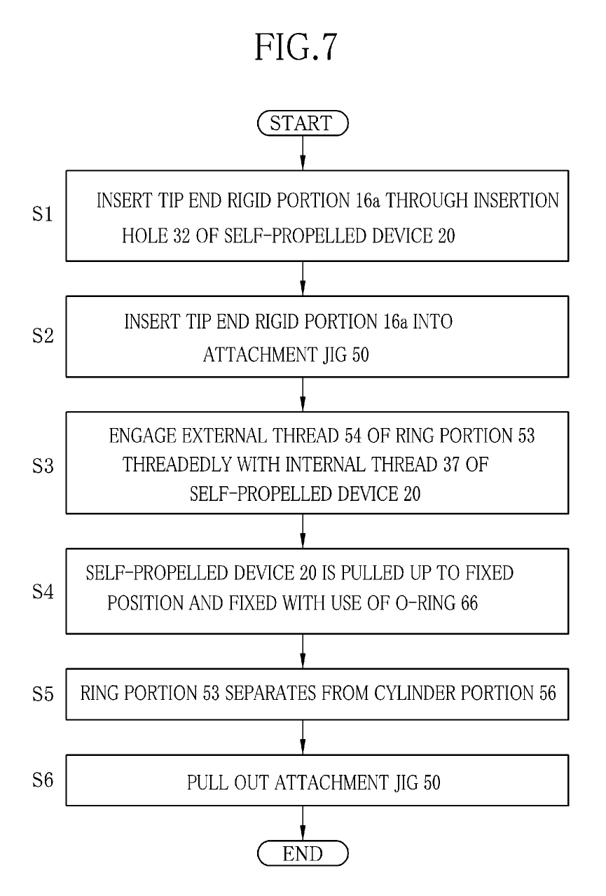

Hereinafter, the effects of the above configuration will be described according to a flowchart shown in FIG. 7. As shown in FIG. 3, at first, the tip end rigid portion 16a is inserted through the insertion hole 32 of the self-propelled device 20. At this time, the tip end rigid portion 16a slightly protrudes from the self-propelled device 20. Subsequently, the attachment jig 50 is inserted into the gap between the inner side of the external cylinder 35 and the outer periphery of the tip end rigid portion 16a, while the O-ring 66 is deformed. At this time, the tip end side of the tip end rigid portion 16a that protrudes from the self-propelled device 20 enters the hole 56a of the cylinder portion 56 through the O-ring 66 and the ring portion 53.

In a case where the tip end side of the tip end rigid portion 16a is made to sufficiently protrude from the self-propelled device 20, the outer peripheral edge of the tip end face 26 of the tip end rigid portion 16a abuts on the shoulder 61, before the attachment jig 50 is pushed into the self-propelled device 20 and the external thread 54 of the ring portion 53 reaches the internal thread 37 of the external cylinder 35 of the self-propelled device 20, and thereby the attachment jig 50 cannot be inserted toward the self-propelled device 20 any more. In this case, the self-propelled device 20 is slid toward the attachment jig 50, and then, the handle portion 55 is rotationally manipulated in the fastening direction of a right-hand screw. Thereby, the external thread 54 of the ring portion 53 is threadedly engaged with the internal thread 37 of the external cylinder 35. In this state, the attachment jig 50 makes the tip end face 26 of the tip end rigid portion 16a abut on the shoulder 61, and therefore the self-propelled device 20 is pulled toward the attachment jig 50.

In a case where the tip end rigid portion 16a is not nearly protruded from the self-propelled device 20, when the attachment jig 50 is inserted into the self-propelled device 20, the external thread 54 of the ring portion 53 reaches the internal thread 37 of the external cylinder 35, and starts to be threadedly engaged with the internal thread 37 of the external cylinder 35. Since the self-propelled device 20 is movable on the tip end rigid portion 16, the base end side of the endoscope 10 is gripped, and the tip end rigid portion 16a is pushed into the self-propelled device 20. Alternatively, the self-propelled device 20 is slid together with the attachment jig 50 toward the base end side of the endoscope 10. After the tip end face 26 of the tip end rigid portion 16a abuts on the shoulder 61, when the handle portion 55 is rotationally manipulated, the external thread 54 is threadedly engaged with the internal thread 37, and the self-propelled device 20 is pulled toward the attachment jig 50.

The self-propelled device 20 is pulled up to a fixed position that is a constant position from the tip end face 26 of the tip end rigid portion 16a whose position is regulated in the axial direction by the shoulder 61. During the movement of the self-propelled device 20, the front end face 66b of the O-ring 66 is pushed by the receiving plane 36a, the O-ring 66 is crushed between the receiving plane 36a and the front end face 53b of the ring portion 53, the inner peripheral surface of the O-ring 66 is pressed against the outer peripheral surface of the tip end rigid portion 16, and consequently, the self-propelled device 20 is fixed to the tip end rigid portion 16a.

If the tip end rigid portion 16a rotates in accordance with the rotation of the attachment jig 50 as described above, an undesirable force in a twisting direction is applied to the endoscope 10. For this reason, the positional regulation of the tip end rigid portion 16a in the axial direction is performed by receiving only the outer peripheral edge of the tip end face 26 of the tip end rigid portion 16a by the inclined shoulder 61, such that the attachment jig 50 is made to slip on the outer peripheral edge of the tip end face 26 upon being rotated, and therefore, an unnecessary torsional force is hardly applied to the endoscope 10.

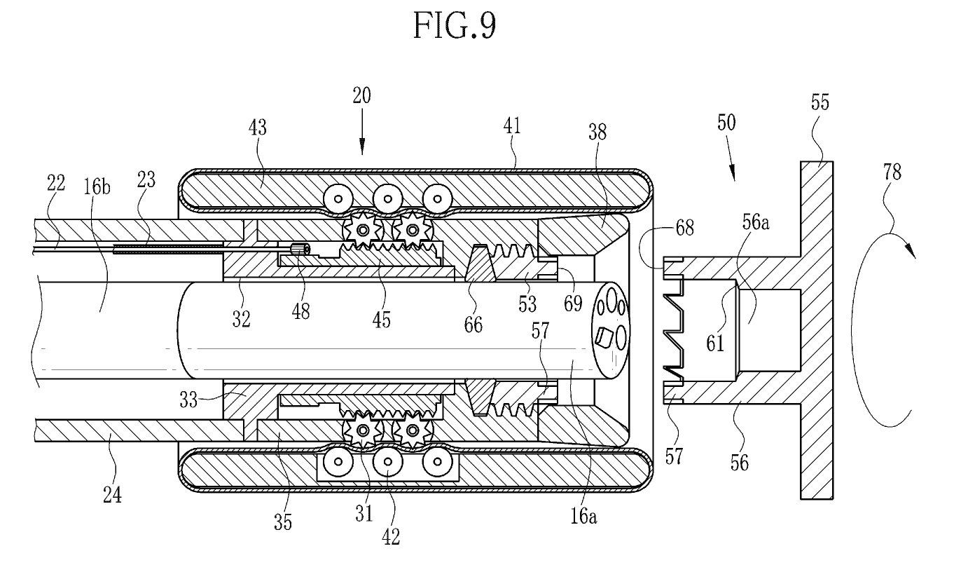

After the ring portion 53 is moved to a predetermined fixed position in this way, when the handle portion 55 is further rotationally manipulated in the direction indicated by an arrow 78 such that a predetermined torque is applied, the thin-walled breaking portion 57 breaks and the ring portion 53 separates from the cylinder portion 56 as shown in FIG. 9. The ring portion 53 remains together with the O-ring 66 between the self-propelled device 20 and the tip end rigid portion 16, and the self-propelled device 20 is brought into a state of being fixed to the tip end rigid portion 16a even if the attachment jig 50 having the cylinder portion 56 is pulled out.

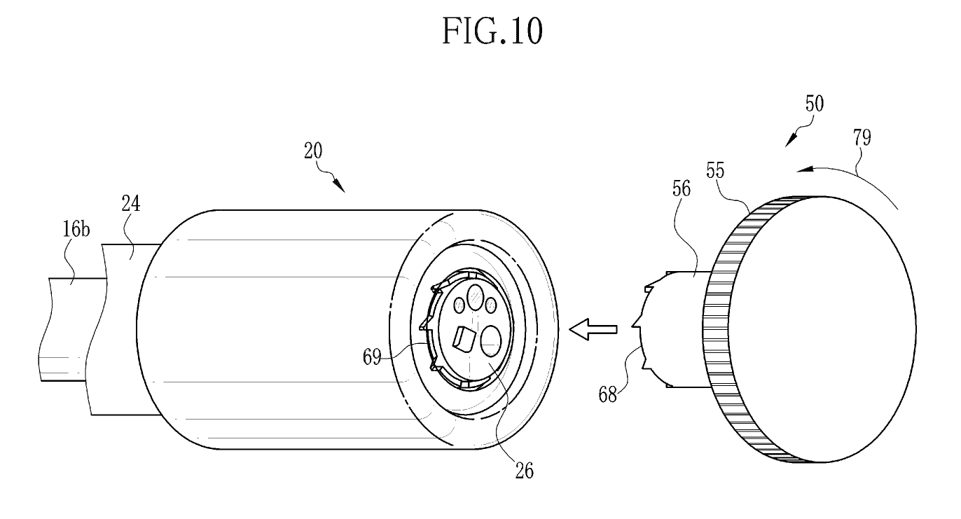

As shown in FIG. 10, in the attachment jig 50 from which the ring portion 53 is cut off, a first saw-toothed broken surface 68 is formed at the front end of the cylinder portion 56. The ring portion 53 cut off from the thin-walled breaking portion 57 remains between the self-propelled device 20 and the tip end rigid portion 16, and a second saw-toothed broken surface 69 is formed at the ring portion 53.

For the purpose of cleaning the endoscope 10, the self-propelled device 20 is detached from the tip end rigid portion 16a. In this case, the cylinder portion 56 of the attachment jig 50 is inserted between the self-propelled device 20 and the tip end rigid portion 16, and the first saw-toothed broken surface 68 and the second saw-toothed broken surface 69 are joined together. Then, the handle portion 55 is rotationally manipulated in the direction indicated by an arrow 79 shown in FIG. 10, such that the respective straight grooves 71 of the first saw-toothed broken surface 68 and the second saw-toothed broken surface 69 engage with each other. The rotation of the handle portion 55 is transmitted to the ring portion 53, and the threaded engagement between the internal thread 37 and the external thread 54 is released. Thus, the ring portion 53 comes off the insertion hole 32. In conjunction with this, the O-ring 66 also comes off together with the ring portion 53.

In the manner as described above, the self-propelled device 20 can be detached from the tip end rigid portion 16. Furthermore, even if the O-ring 66 remains within the insertion hole 32 at the time when the ring portion 53 is detached, since a state where the O-ring 66 is pinched and pressed is released, the O-ring 66 is not brought into press-contact with the outer peripheral surface of the tip end rigid portion 16. Accordingly, the self-propelled device 20 can be detached from the tip end rigid portion 16.

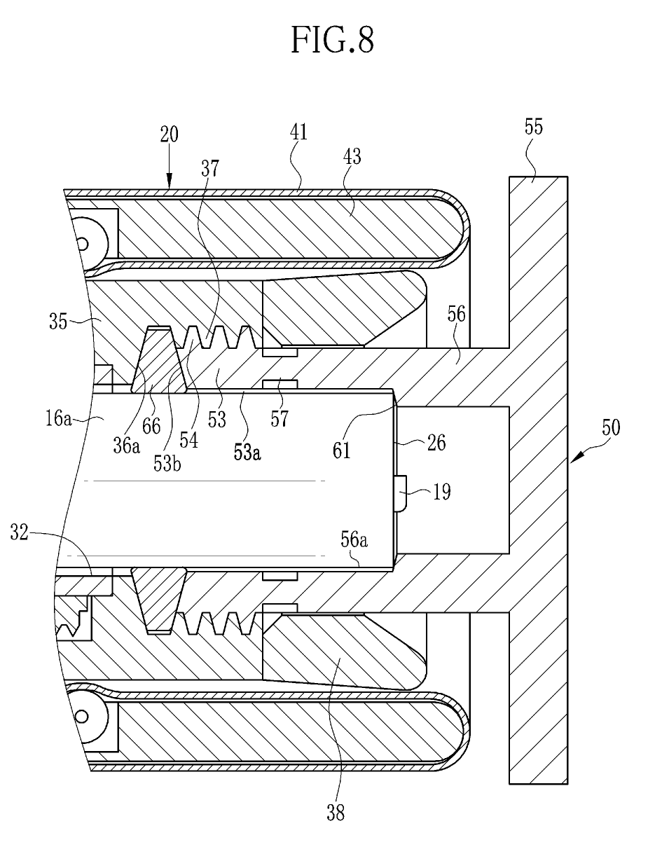

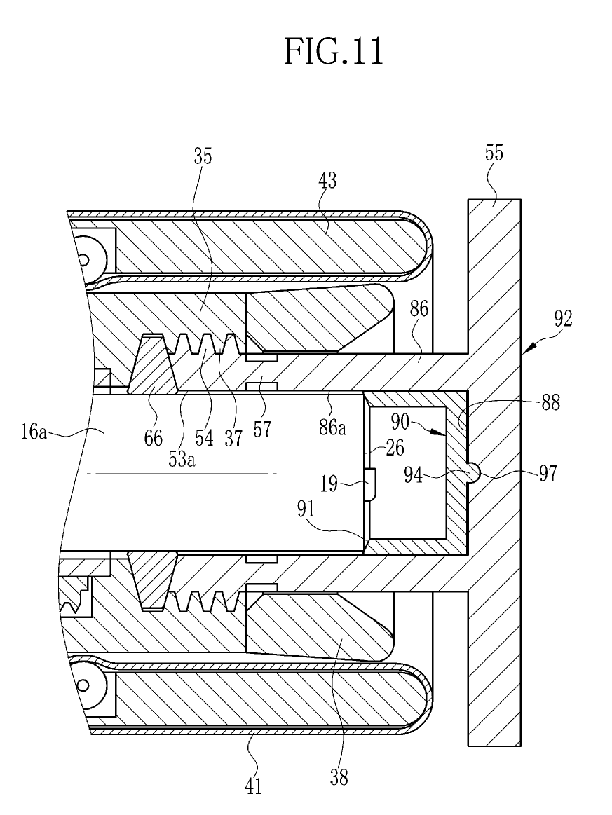

Another embodiment of the present invention is shown in FIG. 11. In this embodiment, in order to regulate the position of the tip end rigid portion 16a, a positioning cylinder 90 is contained in a hole 86a of a cylinder portion 86 of the attachment jig 92. In the bottomed positioning cylinder 90, a hemispherical projection 94 is formed integrally with the bottom face of the bottomed positioning cylinder 90, and the hemispherical projection 94 is fitted into a hemispherical concave portion 97 formed in a bottom wall 88 of the attachment jig 92. The external diameter of the positioning cylinder 90 is almost equal to the diameter of the hole 86a, and an opening edge thereof acts as an inclined shoulder 91. When the tip end rigid portion 16a enters the hole 86a, the outer peripheral edge of the tip end face 26 abuts on the shoulder 91, and thereby the tip end rigid portion 16a is positioned in the axial direction. In this embodiment, since the positioning cylinder 90 can rotate within the hole 86a, when the attachment jig 92 is rotationally manipulated, the rotation of the positioning cylinder 90 also can be utilized in addition to the slip between the outer peripheral edge of the tip end face 26 of the tip end rigid portion 16a and the shoulder 91. Accordingly, there are advantages that the rotational manipulation of the attachment jig 92 is easy, and further, an unnecessary torsional force is not applied to the endoscope. Note that, the components which are the same as those of the embodiment shown in FIG. 8 are denoted by the same reference numerals, and the explanation thereof is omitted.

The handle portion 55 may have a cross-like shape instead of the discoid shape. Further, the inclined shoulder of the position regulating portion may be extended to the center of the hole such that the position regulating portion has a conical shape.

Furthermore, the positioning cylinder 90 may be rotatable along an axis penetrating the positioning cylinder 90 and the handle portion 55.

Various changes and modifications are possible in the present invention and may be understood to be within the present invention.

What is claimed is:

1. An attachment jig for use in fixing a self-propelled device to a tip end rigid portion located at a tip end of an insertion section of an endscope, said attachment jig comprising:
a cylinder portion to be inserted into a gap formed between an outer peripheral surface of said tip end rigid portion and an inner peripheral surface of said self-propelled device from the side of a tip end face of said tip end rigid portion, in a state that said tip end rigid portion is inserted into said self-propelled device;
a position regulating portion provided inside said cylinder portion, said position regulating portion abutting on said tip end face of said tip end rigid portion so as to define an insertion position of said tip end rigid portion inside said cylinder portion;
a ring portion which is separably provided at a front end side of said cylinder portion and threadedly engaged with said self-propelled device, said ring portion fixing said self-propelled device to a fixed position on said tip end rigid portion; and
a handle portion provided at a rear end side of said cylinder portion, said handle portion serving for causing relative movement between said self-propelled device and said tip end rigid portion through the threaded engagement, fixing said self-propelled device to said fixed position, separating said ring portion from said cylinder portion after fixing said self-propelled device, and taking out said cylinder portion from said tip end rigid portion while leaving said ring portion in said self-propelled device.

2. The attachment jig according to claim 1, wherein said ring portion has an elastic member attached to its front end, and said elastic member is pinched between said ring portion and a part of said self-propelled device and pressed against the outer peripheral surface of said tip end rigid portion so as to fix said self-propelled device to said fixed position.

3. The attachment jig according to claim 2, wherein said elastic member is an O-ring made of rubber.

4. The attachment jig according to claim 2, wherein the threaded engagement is conducted using an external thread formed at an outer periphery of said cylinder portion and an inner thread formed at an inner peripheral surface of said self-propelled device.

5. The attachment jig according to claim 4, wherein said position regulating portion is a shoulder disposed in said cylinder portion so as to receive an outer peripheral edge of said tip end rigid portion.

6. The attachment jig according to claim 5, wherein said shoulder has a ring shape inclined such that its diameter increases toward said handle portion.

7. The attachment jig according to claim 6, wherein said shoulder is an opening edge of a position regulating cylinder, and said position regulating cylinder is fitted into said cylinder portion.

8. The attachment jig according to claim 7, wherein said position regulating cylinder is rotatable inside said cylinder portion with use of a hemispherical projection and a hemispherical concave portion.

9. The attachment jig according to claim 5, wherein said ring portion is separated from said cylinder portion when said handle portion is caused to rotate by at least a predetermined torque after said self-propelled device is fixed to said fixed position.

10. The attachment jig according to claim 9, wherein said attachment jig is integrally molded from plastic, in which a thin-walled breaking portion is disposed between said ring portion and said cylinder portion.

11. The attachment jig according to claim 10, wherein when said handle portion is caused to rotate in a first direction by a torque below the predetermined level, said self-propelled device is moved to said fixed position, and when said handle portion is caused to rotate at said fixed position by a torque of at least the predetermined level, said thin-walled breaking portion is broken to form two broken surfaces.

12. The attachment jig according to claim 11, wherein said thin-walled breaking portion has a saw-tooth shape, such that after said thin-walled breaking portion is broken, said two broken surfaces are not engaged with each other when said handle portion is caused to rotate in said first direction, and said two broken surfaces are engaged with each other when said handle portion is caused to rotate in a second direction opposite to said first direction.

13. The attachment jig according to claim 12, wherein said thin-walled breaking portion having a saw-tooth shape consists of a plurality of straight grooves extending in an axial direction of said cylinder portion, a plurality of diagonal grooves, and a plurality of circular arc grooves extending in a circumferential direction of said cylinder portion, said circular arc groove connecting said straight groove and said diagonal groove adjacent to each other.
